(19) United States
(12) Patent Application Publication
(10) Pub. No.: US 2015/0199904 A1
(43) Pub. Date: Jul. 16, 2015

(54) SYSTEM AND METHOD FOR CONTROLLING VEHICLE AT INTERSECTION

(71) Applicant: Electronics and Telecommunications Research Institute, Daejeon (KR)

(72) Inventors: Sang Woo LEE, Daejeon (KR); Byung Gil LEE, Daejeon (KR); Jung Chan NA, Daejeon (KR)

(73) Assignee: Electronics and Telecommunications Research Institute, Daejeon (KR)

(21) Appl. No.: 14/221,683

(22) Filed: Mar. 21, 2014

(30) Foreign Application Priority Data
Jan. 13, 2014 (KR) 10-2014-0003753

(51) Int. Cl. G08G 1/0967; G07C 5/00

(52) U.S. Cl. CPC G08G 1/096783; G07C 5/008

(57) ABSTRACT

Disclosed are a system and a method for controlling a vehicle at an intersection, and more particularly, disclosed is a technology that can efficiently control a start time of a vehicle that is waiting for a signal at an intersection. The system includes: a simultaneous starting group designating unit which designates vehicles of a simultaneous starting group, which are capable of starting simultaneously, among waiting vehicles when receiving an intersection entering state message from vehicles; a session key generating unit generating a session key for the simultaneous starting group; a message generating unit which generates a start request message for the simultaneous starting group; and a control unit which receives the intersection entering state message and transmits the session key and the start request message to the vehicles corresponding to the simultaneous starting group.

### CROSS-REFERENCE TO RELATED APPLICATIONS

This application claims priority to and the benefit of Korean Patent Application No. 10-2004-0003753 filed in the Korean Intellectual Property Office on Jan. 13, 2014, the entire contents of which are incorporated herein by reference.

### TECHNICAL FIELD

The present invention relates to a system and a method for controlling a vehicle at an intersection, and more particularly, to a technology that can efficiently control a start time of a vehicle that is waiting for a signal at an intersection.

### BACKGROUND ART

In general, a transportation controller that controls traffic of a vehicle is used at an intersection. The transportation controller allocates a traffic priority of a vehicle, which enters the intersection, by using (red, yellow, and green) signals of a signal lamp installed for each direction of the intersection.

Among the signals on the signal lamp, the green signal is a signal indicating that the vehicle can enter the intersection, the yellow signal is used for informing a driver that the green signal is changing to a red signal, and the red signal is a signal indicating that the vehicle cannot enter the intersection.

In spite of a regulation of the signal lamp, an importance of an accident which occurs at the intersection is very high practically. A global positioning system (GPS) receiver as a system that guides traffic for a driver is incorporated in the vehicle in order to reduce accidents at the intersection. Further, a navigation device is used, which installs a gyroscope or a velocity sensor in the vehicle to notify that the intersection is present in a vehicle progress direction based on a velocity or a position of the vehicle. However, in general, the largest difficulty which the driver driving the vehicle meets is that the driver cannot know how long the driver waits for the green signal as an entering signal at the time of entering the intersection. Most drivers decelerate the vehicle or accelerate the vehicle in order to rapidly pass through the intersection in some cases through prediction in advance at the time of entering the intersection.

Additionally, when the driver stops the vehicle to wait for the signal light at the intersection, the driver cannot know when to receive a go signal (green signal) for a progress direction. As a result, the driver may be distracted by distributing his/her attention while waiting, such that the driver does not recognize a change of the signal, which interferes with a traffic flow.

These problems make it more difficult for the driver to predict especially at rush hour when vehicular traffic is high or in the case where traffic congestion is increased due to snow or rain when the driver drives the vehicle to other cities. In this case, even bump-on-bump at the intersection or a vehicle accident is caused.

A vehicle transportation controller scientificates or automates operation and management of a transportation system by developing and using electronic, control and communication up-to-date transportation technology for transportation facility. That is, the vehicle transportation controller has evolved to a form of an information transportation system (ITS) that means a transportation system which improves efficiency and safety of transportation.

In particular, vehicle driving safety is increased and a convenient service is provided to the driver, by using vehicle communication technology (intervehicle communication and communication between the vehicle and a roadside device). Ultimately, the transportation system is developed to attain an effect to reduce traffic accidents and increase transportation efficiency. In particular, a scheme for increasing the transportation efficiency using communication between the vehicle and an infrastructure can be provided.

A vehicle control method using the communication between the vehicle and the infrastructure in the related art was provided as a means for solving an object for preventing a collision between vehicles at the intersection. However, the vehicle control method using the communication between the vehicle and the infrastructure in the related art cannot solve inefficient traffic of the vehicle which occurs because a start of the vehicle, which waits for the signal at the intersection, is gradually delayed for each vehicle. Accordingly, a more appropriate technical scheme is required, which can solve the problems than a vehicle driving guide system used in the related art or prediction by a driver with bad judgment according to a situation.

### SUMMARY OF THE INVENTION

The present invention has the following characteristics.

First, among vehicles which are waiting for a signal at an intersection, vehicles, which can start simultaneously during the time when a signal lamp is turned on as a drivable indication lamp (green lamp), are registered in a simultaneous starting group to allow the vehicles registered in the corresponding group to start simultaneously, thereby reducing the number of waiting vehicles.

Second, when a vehicle start response is transmitted to an intersection control system at the time when the vehicles registered in the simultaneous starting group start, the waiting vehicles can be efficiently managed by cancelling the simultaneous starting group and updating the simultaneous starting group.

An exemplary embodiment of the present invention provides a system for controlling a vehicle at an intersection, including: a simultaneous starting group designating unit which designates vehicles of a simultaneous starting group, which are capable of starting simultaneously, among waiting vehicles when receiving an intersection entering state message from vehicles; a message generating unit which generates a start request message for the simultaneous starting group; and a control unit which receives the intersection entering state message and transmits a session key and the start request message to the vehicles corresponding to the simultaneous starting group.

Another exemplary embodiment of the present invention provides a system for controlling a vehicle at an intersection, including: an intersection control device which transmits a start request message to vehicles by designating the vehicles of a simultaneous starting group, which are capable of starting simultaneously, among waiting vehicles when receiving an intersection entering state message; and a vehicle guide device which transmits the intersection entering state message when the vehicle enters an intersection and transmits a vehicle start response signal to the intersection control device when the start request message is transmitted to vehicles corresponding to the simultaneous starting group.

Yet another exemplary embodiment of the present invention provides a method for controlling a vehicle at an intersection, including: receiving an intersection entering state message from a vehicle entering an intersection in a waiting state; determining whether positions of the vehicles that receive the intersection entering state message are within a simultaneous start range; registering the vehicles in a simultaneous starting group and storing information on the vehicles in a storage unit when the positions of the vehicles are within the simultaneous start range; and transmitting a start request message to the vehicles registered in the simultaneous starting group.

The present invention provides the following effects.

First, vehicles registered in a simultaneous starting group are allowed to simultaneously start at an intersection to reduce the number of waiting vehicles and reduce traffic congestion.

Second, a waiting time of a vehicle which is waiting for a signal is reduced to prevent air pollution due to idling of the vehicle.

Third, the vehicle can be efficiently managed by managing and updating the vehicle of the simultaneous starting group.

Fourth, high-speed real-time message transmission is available by using a method for broadcasting a start request message to a plurality of vehicles designated as the simultaneous starting group in an intersection control device.

Fifth, the message is encrypted by the intersection control device to prevent breach of security due to message forgery and tapping.

The exemplary embodiment of the present invention is used for an example, and various modifications, changes, substitutions, and additions can be made through the technical spirit and range of the appended claims by those skilled in the art, and it will be appreciated that the modifications and changes are included in the appended claims.

### BRIEF DESCRIPTION OF THE DRAWINGS

FIG. 1 is a configuration diagram of a system for controlling a vehicle at an intersection according to an exemplary embodiment of the present invention.

FIG. 2 is a diagram for describing a method for designating a simultaneous starting group in an intersection control device of FIG. 1.

FIG. 3 is a flowchart for describing an operation of the intersection control device of FIG. 1.

FIG. 4 is a flowchart for describing an operation of a method for controlling a vehicle at an intersection according to another exemplary embodiment of the present invention.

### DETAILED DESCRIPTION

Hereinafter, exemplary embodiments of the present invention will be described in detail with reference to the accompanying drawings.

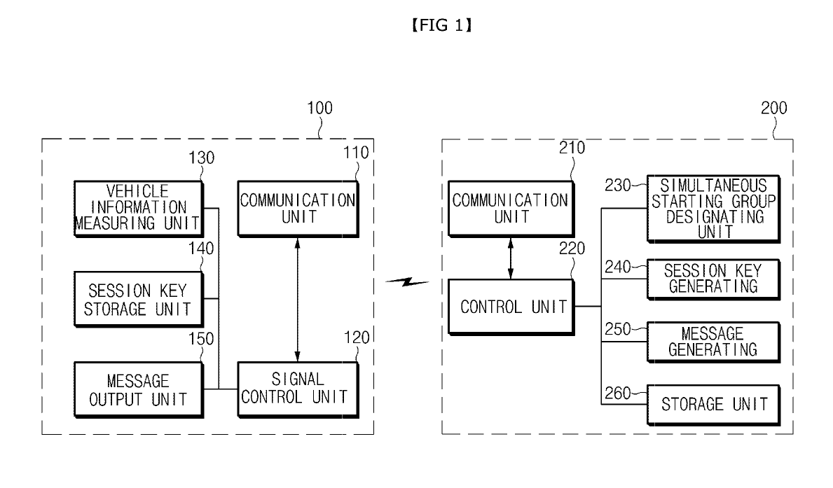

FIG. 1 is a configuration diagram of a system for controlling a vehicle at an intersection according to an exemplary embodiment of the present invention.

The exemplary embodiment of the present invention includes a vehicle guide device 100 and an intersection control device 200. The vehicle guide device 100 includes a communication unit 110, a signal control unit 120, a vehicle information measuring unit 130, a session key storage unit 140, and a message output unit 150. In addition, the intersection control device 200 includes a communication unit 210, a control unit 220, a simultaneous starting group designating unit 230, a session key generating unit 240, a message generating unit 250, and a storage unit 260.

Herein, the communication unit 110 transmits/receives a signal to/from the intersection control device 200 by using a wireless communication method. The signal control unit 120 receives the signal from the intersection control device 200 through the communication unit 110 and transmits the signal to the intersection control device 200. In addition, the signal control unit 120 controls operations of the vehicle information measuring unit 130, the session key storage unit 140, and the message output unit 150.

In particular, the signal control unit 120 transmits an intersection entering state message of a vehicle to the intersection control device 200 in response to information applied from the vehicle information measuring unit 130. Herein, the intersection entering state message may include an ID (identification number) of the vehicle, a position of the vehicle, a current time, and the like. In addition, the signal control unit 120 transmits a response signal to a start of the vehicle to the intersection control device 200 in response to the information applied from the vehicle information measuring unit 130.

The signal control unit 120 stores session key information on a simultaneous starting group, which is applied from the intersection control device 200, in the session key storage unit 140. Further, when the signal control unit 120 receives a start request message for the simultaneous starting group from the intersection control device 200, the signal control unit 120 transfers the start request message to the message output unit 150.

The vehicle information measuring unit 130 outputs information on the vehicle to the signal control unit 120 by sensing a stop state, a start state, and the like of the vehicle. The session key storage unit 140 stores a session key applied from the signal control unit 120. The signal control unit 120 determines whether the corresponding vehicle corresponds to the simultaneous starting group in response to information on the session key stored in the session key storage unit 140.

When the message output unit 150 receives a start message for the simultaneous starting group from the intersection control device 200, the message output unit 150 transmits the start message according to a control by the signal control unit 120. Herein, the message output unit 150 may transmit a start-possible state message through a speaker or a display screen attached to the inside of the vehicle.

Meanwhile, the communication unit 210 of the intersection control device 200 transmits/receives the signal to/from the vehicle guide device 100. The control unit 220 receives the signal from the vehicle guide device 100 through the communication unit 210 and transmits the signal to the vehicle guide device 100. In addition, the control unit 220 controls operations of the simultaneous starting group designating unit 230, the session key generating unit 240, the message generating unit 250, and the storage unit 260.

In particular, the control unit 220 transmits session key information on the simultaneous starting group generated from the session key generating unit 240 to the vehicle guide device 100 through the communication unit 210. In addition, the control unit 220 transmits the start request message of the vehicle for the simultaneous starting group to the vehicle guide device 100 in response to the message information applied from the message generating unit 250.

When the control unit 220 receives the response signal to the start of the vehicle from the vehicle guide device 100, the control unit 220 cancels the information on the simultaneous starting group stored in the storage unit 260 and newly updates the information on the simultaneous starting group.

The simultaneous starting group designating unit 230 designates a range of vehicles which may start simultaneously and verifies information indicating a range of vehicle which is waiting at the intersection may start simultaneously to output the information to the control unit 220.

That is, the simultaneous starting group designating unit 230 verifies information on a vehicle, which transmits an intersection entering state message, to designate the simultaneous starting group. For example, the simultaneous starting group designating unit 230 calculates the number of vehicles that may pass during the time when a signal lamp of the intersection is a go lamp (green lamp). In addition, the simultaneous starting group designating unit 230 verifies whether the last vehicle is present within a position on a road where the vehicle stops. To this end, the simultaneous starting group designating unit 230 may include sensing apparatuses such as a radar and a video camera.

The session key generating unit 240 generates a session key to be distributed to a vehicle, which is designated as the simultaneous starting group, among the vehicles that are waiting at the intersection. The session key generating unit 240 may include a random number generator in order to generate the session key to be distributed to the vehicle designated as the simultaneous starting group.

The message generating unit 250 generates a start request message to be transmitted to the vehicle designated as the simultaneous starting group. When the signal lamp at the intersection is a (red) stop lamp, the start request message generated by the message generating unit 250 may include a simultaneous start estimation time of the vehicle registered in the simultaneous starting group.

The message generating unit 250 encrypts the start request message by using the session key generated by the session key generating unit 240. In addition, the message generating unit 250 encrypts the session key into a public key of each vehicle in order to distribute the session key to the vehicle designated as the simultaneous starting group. As a result, the intersection control device 200 encrypts and transmits the session key to defend message tapping and forgery attacks.

As such, the exemplary embodiment of the present invention has an advantage in that the high-speed signal processing is available because the start request messages encrypted with the session key are simultaneously broadcasted to a plurality of vehicles designated as the simultaneous starting group.

The storage unit 260 stores the information on the vehicle designated as the simultaneous starting group. That is, when the vehicle that is waiting at the intersection transmits the information on the intersection entering state to the intersection control device 200, the control unit 220 receives the information on the vehicle and stores the received information in the storage unit 260. In addition, when the storage unit 260 receives information indicating that the vehicle registered in the simultaneous starting group has started, the storage unit 220 cancels the information on the simultaneous starting group according to the control and updates the stored information.

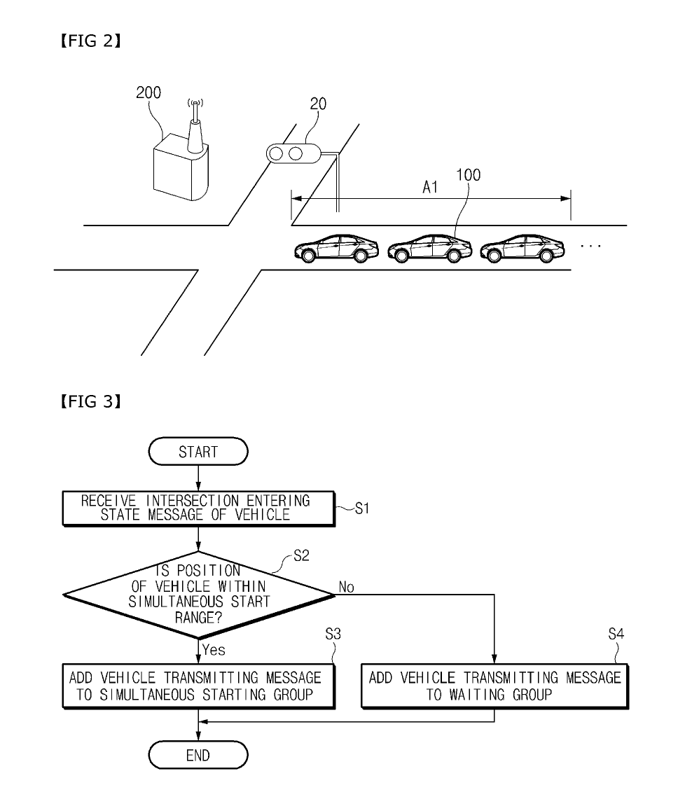

FIG. 2 is a diagram for describing a method for designating the simultaneous starting group in the intersection control device 200 of FIG. 1.

The intersection control device 200 is positioned on the roadside of the signal intersection and converts data associated with an intersection control into a radio signal to radially transmit the radio signal to a predetermined radius. A vehicle attached with the vehicle guide device 100 is driven toward a destination and a plurality of intersections may be provided on a driving route. In addition, a case in which the vehicle is being driven may also include a case in which the vehicle is driven on a predetermined route by using a route guide system such as a navigation system.

A driver of the vehicle checks a signal of a signal lamp 20 in front in advance and enters the intersection when the signal of the signal lamp 20 is a go signal, for example, a green signal and stops at the intersection when the signal of the signal lamp 20 is a stop signal (red signal).

The driver of the vehicle designated as the simultaneous starting group passes through the intersection while maintaining a driving mode from the time of receiving the start request message for the simultaneous starting group from the intersection control device 200 to the time of ending receipt of the message.

The vehicle control device at the intersection according to the exemplary embodiment of the present invention allows vehicles, among waiting vehicles that are present on the driving route, as many as the vehicles designated by the simultaneous starting group designating unit 230 to pass through the intersection when the go signal is turned on. That is, the simultaneous starting group designating unit 230 designates vehicles of the simultaneous starting group, which may pass through the intersection at once when the go signal is turned on, through the session key. In addition, when the go lamp is turned on, all vehicles which are within a designated simultaneous start range A1 pass through the intersection simultaneously to prevent entering the intersection due to a judgment error of the driver.

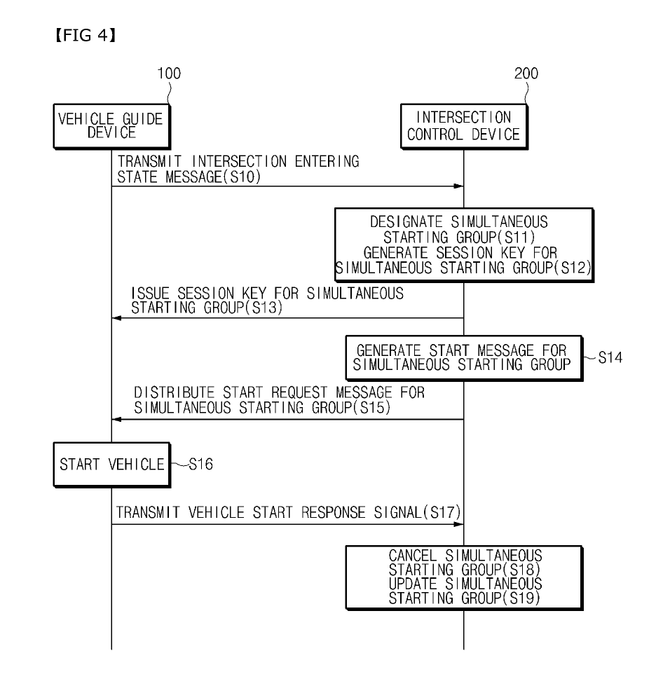

FIG. 3 is a flowchart for describing an operation of the intersection control device 200 of FIG. 1.

The vehicle attached with the vehicle guide device 100 stops by reaching a region where the vehicle is capable of receiving the intersection control signal from the intersection control unit 200. The intersection control unit 200 receives the intersection entering state message from the vehicles that enter the intersection when a signal lamp of a corresponding traffic lane is the stop lamp (red lamp) (step S1).

The simultaneous starting group designating unit 230 determines whether positions of the vehicles that receive the intersection entering state message are within the simultaneous start range A1 (step S2). Herein, the simultaneous start range A1 means a position on the road where the last vehicle stops by calculating the number of vehicles which may pass through the intersection during the time when the signal lamp at the intersection is the go lamp (green lamp).

That is, the simultaneous starting group designating unit 230 extracts the position of the vehicle from the intersection entering state message to determine whether the position is within or out of the simultaneous start range A1. In this case, in order to more accurately verify the corresponding position of the vehicle, the simultaneous starting group designating unit 230 may use vehicle identification devices such as a radar and a camera.

When the positions of the vehicles receiving the intersection entering state message are within the simultaneous start range A1, the vehicles are registered in the simultaneous starting group and information on the vehicles is stored in the storage unit 260 (step S3). Herein, the simultaneous starting group means a group of vehicles which start simultaneously when the signal lamp is the go lamp (green lamp).

On the contrary, when the positions of the vehicles receiving the intersection entering state message are out of the simultaneous start range A1, the vehicles are registered in a waiting group (step S4). Herein, the waiting group means a group of vehicles which start simultaneously as vehicles that are out of the simultaneous start range A1 during the time when a subsequent go lamp (green lamp) is turned on.

FIG. 4 is a flowchart for describing an operation of a method for controlling a vehicle at an intersection according to another exemplary embodiment of the present invention.

First, when a signal lamp of a corresponding traffic lane is the stop lamp (red lamp), the vehicles that enter the intersection transmit an intersection entering state message to the intersection control unit 200 (step S10).

That is, the vehicle information measuring unit 130 of the vehicle guide device 100 senses a brake signal of the vehicle and the like to output the sensed signal to the signal control unit 120. When the brake signal and the like are sensed from the vehicle information measuring unit 130, the signal control unit 120 determines that the vehicle is in a waiting state. Accordingly, the signal control unit 120 transmits the intersection entering state message to the intersection control device 200 through the communication unit 110.

Thereafter, the simultaneous starting group designating unit 230 of the intersection control device 200 determines whether the vehicles transmitting the intersection entering state message are in the simultaneous start range A1. In addition, the simultaneous starting group designating unit 230 designates the vehicles within the simultaneous start range A1 as the simultaneous starting group (step S11). Here, the simultaneous starting group means a group of vehicles which simultaneously start when the signal lamp is the go lamp (green lamp).

Subsequently, the session key generating unit 240 of the intersection control device 200 generates a session key of the simultaneous starting group (step S12). In addition, the control unit 220 issues the session key for the simultaneous starting group generated from the session key generating unit 240 to transmit the issued session key to the vehicle guide device 100 registered in the simultaneous starting group (step S13). Then, the corresponding session key is stored in the session key storage unit 140 of the vehicle guide device 100.

Thereafter, the message generating unit 250 of the intersection control device 200 generates a start request message to be transmitted to the vehicles registered in the simultaneous starting group (step S14). In addition, the control unit 220 transmits the start request message generated by the message generating unit 250 to the vehicle guide device 100 registered in the simultaneous starting group (step S15).

Then, the message output unit 150 of the vehicle guide device 100 outputs the start request message indicating that the vehicles may enter the intersection. The driver of the vehicle registered in the simultaneous starting group recognizes the message output through the message output unit 150 to start the vehicle at the intersection (step S16).

In this case, the vehicle receiving the start request message may start without interference of the driver in link with the vehicle internal system in order to start at the same time of receiving the start request message. However, when the vehicle senses that a vehicle ahead does not start by using a radar and an image camera device of the vehicle, the vehicle does not start, but may wait.

The vehicle receiving the start request message expresses a start message by using the vehicle internal message output unit 150 or an attachable display device to accelerate the start of the driver, in order to start simultaneously upon receiving the start request message.

Next, the signal control unit 120 of the vehicle guide device 100 recognizes the starting of the vehicle through the sensing signal of the vehicle information measuring unit 130. As a result, the signal control unit 120 transmits a response signal representing a start state of the vehicle to the intersection control device 200 (step S17).

Next, when receiving the response signal indicating that the vehicle starts, the control unit 220 of the intersection control device 200 cancels the simultaneous starting group stored in the storage unit 260 (step S18). In addition, the control unit 220 updates the simultaneous starting group by using the information on the waiting vehicles out of the simultaneous start range in step S11 (step S19).

1. A system for controlling vehicles at an intersection, comprising:
a simultaneous starting group designating unit configured to designate a simultaneous starting group of vehicles, which are to enter the intersection in a same batch, among all vehicles to be entering the intersection, the simultaneous starting group having a session key issued thereto, different simultaneous starting groups having different session keys;
a message generating unit configured to
generate a start request message for the simultaneous starting group, and
encrypt the start request message using its corresponding session key; and
a control unit configured to control the transmission of the session key and the start request message to the vehicles in the simultaneous starting group.

2. The system of claim 1, wherein the control unit cancels and updates the simultaneous starting group when receiving a start response signal from the vehicles.

3. The system of claim 1, wherein
the control unit is configured to receive an intersection entering state message from each of the vehicles to be entering the intersection, and
the system further includes a storage unit that stores information on each vehicle that transmits the intersection entering state message.

4. The system of claim 3, wherein the intersection entering state message of each vehicle includes at least one of an ID (identification number) of the vehicle, a position of the vehicle, and a current time.

5. (canceled)

6. The system of claim 1, wherein the simultaneous starting group designating unit includes at least one sensing apparatus of a radar and a video camera in order to verify a position of each vehicle.

7. The system of claim 1, further comprising:
a session key generating unit which generates the session key for the simultaneous starting group.

8. The system of claim 1, wherein the start request message generated by the message generating unit includes a simultaneous start estimation time of the vehicles in the simultaneous starting group.

9. (canceled)

10. The system of claim 1, wherein the message generating unit encrypts the session key to a public key for each vehicle in the simultaneous starting group.

11. A system for controlling vehicles at an intersection, comprising:
an intersection control device configured to
designate a simultaneous starting group of vehicles, which are to enter the intersection in a same batch, among all vehicles to be entering the intersection, the simultaneous starting group having a session key issued thereto, different simultaneous starting groups having different session keys, and
to transmit a start request message to the vehicles in the simultaneous starting group; and
a vehicle guide device of each of the vehicles, configured to
transmit an intersection entering state message to the intersection control device when said each vehicle is to enter the intersection, and
transmit a vehicle start response signal to the intersection control device when the start request message is transmitted to said each vehicle and said each vehicle is in the simultaneous starting group.

12. The system of claim 11, wherein the vehicle guide device includes:
a vehicle information measuring unit which detects a stop or start state of said each vehicle;
a session key storage unit which stores the session key;
a message output unit which transmits the start request message for the simultaneous starting group to inside of said each vehicle; and
a signal control unit which
transmits the intersection entering state message and the start response signal to the intersection control device in response to an output of the vehicle information measuring unit, and
determines whether said each vehicle is in the simultaneous starting group in response to information on the session key stored in the session key storage unit.

13. The system of claim 11, wherein the intersection control device includes:
a simultaneous starting group designating unit which determines whether a vehicle is within a simultaneous start range when receiving the intersection entering state message from the vehicle and designates the vehicle to be in the simultaneous starting group;
a session key generating unit which generates the session key for the simultaneous starting group;
a message generating unit which generates the start request message for the simultaneous starting group; and
a control unit which receives the intersection entering state message and transmits the session key and the start request message to the vehicles in the simultaneous starting group.

14. The system of claim 13, wherein the control unit cancels and updates the simultaneous starting group when receiving a start response signal from the vehicles.

15. The system of claim 13, wherein the intersection control device further includes a storage unit which stores information on each vehicle that transmits the intersection entering state message.

16. (canceled)

17. The system of claim 13, wherein the message generating unit encrypts the session key to a public key for each vehicle in the simultaneous starting group.

18. A method for controlling vehicles at an intersection, comprising:
receiving an intersection entering state message from each of the vehicles to be entering the intersection;
determining whether a position of each of the vehicles that receive the intersection entering state message is within a simultaneous start range;
registering all vehicles of which the positions are determined to be within the simultaneous start range in a simultaneous starting group, and storing information on the vehicles in a storage unit;
generating a start request message and a session key for the simultaneous starting group, different simultaneous starting groups having different session keys, and encrypting the start request message using the session key; and
transmitting the start request message and the session key to each vehicle upon registering said each vehicle in the simultaneous starting group.

19. The method of claim 18, further comprising:
registering a vehicle in a waiting group when the position of the vehicle is out of the simultaneous start range.

20. The method of claim 18, further comprising:
cancelling the simultaneous starting group and updating the simultaneous starting group with information on waiting vehicles when receiving a response signal representing a start state of a vehicle.
